(19) United States
(12) Patent Application Publication
(10) Pub. No.: US 2006/0044832 A1
(43) Pub. Date: Mar. 2, 2006

(54) Light guide plate and backlight module employing the same

(75) Inventors: Di Feng, Beijing (CN); Xing-Peng Yang, Beijing (CN); Guo-Fan Jin, Beijing (CN); Hai-Tao Liu, Beijing (CN); Ying-Bai Yan, Beijing (CN); Shou-Shan Fan, Beijing (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignees: Tsinghua University, Beijing City (CN); HON HAI Precision Industry CO., LTD., Tu-Cheng City (TW)

(21) Appl. No.: 11/214,362

(22) Filed: Aug. 29, 2005

(30) Foreign Application Priority Data
Sep. 2, 2004 (CN) 200410051379.5

(51) Int. Cl. F21V 7/04

(52) U.S. Cl. 362/615

(57) ABSTRACT

A light guide plate includes an incident surface, a reflecting surface, and a plurality of V-shaped projections arrayed on the reflecting surface. The V-shaped projections extend outwardly from the reflecting surface. Each of the V-shaped projection has a triangular cross-section. A vertex angle of the cross-section is in the range from 40° to 95°. A first base angle of the cross-section is in the range from 70° to 90°. A second base angle of the cross-section is in the range from 15° to 50°. A distribution density of the V-shaped projections progressively increases along a direction away from the incident surface. A size of the V-shaped projections progressively increases along a direction away from the incident surface. The light guide plate can be one of a flat sheet having a uniform thickness and a wedge-shape piece.

### BACKGROUND OF THE INVENTION

1. Field of the Invention

The present invention relates to light guide plates and backlight modules, and particularly to an edge-lighting type light guide plate and a backlight module employing such light guide plate.

2. General Background

Numerous LCDs (liquid crystal displays) employ a backlight system for providing the illumination needed to light up the display. A typical backlight system generally comprises a light guide plate for converting a point light source or a linear light source into a plane light source. The light guide plate is generally comprised of an incident surface, a reflecting surface, an emergence surface, and remaining three side surfaces. The light guide plate is generally a flat sheet having a uniform thickness, or a wedge-shaped block.

Referring to FIG. 8, this shows part of a conventional edge-lighting type backlight module 10 for a liquid crystal display. The backlight module 10 includes a linear light source 11, a light guide plate 13, a reflector 12, a diffuser 14, and a prism sheet 15. The reflector 12 is utilized to redirect light beams that have escaped from a reflecting surface of the light guide plate 13 back into the light guide plate 13 via the reflecting surface. The diffuser 14 is utilized to scatter light beams emitting from the light guide plate 13, so as to improve uniformity of intensity of light over the emissive region of the light guide plate 13. The prism sheet 15 is utilized to converge scattered light beams so as to enhance luminance. However, in general, light beams that emit from the light guide plate 13 are not perpendicular to an emergence surface of the light guide plate 13. A number of additional complementary optical elements, such as the diffuser 14 and the prism sheet 15, have to be employed to redirect the light beams to emit perpendicularly from the prism sheet 15.

Referring to FIG. 9, this represents another conventional edge-lighting type light guide plate, as disclosed in U.S. Pat. No. 6,130,930. A plurality of substantially parallel optical elements is formed on a reflecting surface of the light guide plate 20, for redirecting light beams from an incident surface to, and through, an emergence surface by total internal reflection. Each of the optical elements includes a first facet that is nonparallel to the emergence surface, and a mirrored second facet that is also nonparallel to the emergence surface. Consequently, almost all the light beams can be reflected and directed to exit from the emergence surface via the mirrored second facets of the light guide plate 20. However, light beams emitting from such light guide plate 20 are generally not perpendicular to the emergence surface. A diffuser and a prism sheet have to be employed to redirect the light beams to exit perpendicularly from the prism sheet.

What is needed, therefore, is a light guide plate which is capable of directing light beams to exit substantially perpendicularly therefrom, and thereby achieve efficiency of light utilization and uniformity of luminance without the aid of extra complementary optical elements such as diffusers and prism sheets.

### SUMMARY

In one aspect of the present invention, there is provided a light guide plate. The light guide plate includes an incident surface, a reflecting surface, and a plurality of V-shaped projections arrayed on the reflecting surface. The V-shaped projections extend outwardly from the reflecting surface and each of the V-shaped projections has a triangular cross-section. A vertex angle of the cross-section is in the range from 40° to 95°. A first base angle of the cross-section is in the range from 70° to 90°. A second base angle of the cross-section is in the range from 15° to 50°.

A distribution density of the V-shaped projections progressively increases along a direction away from the incident surface. Sizes of the V-shaped projections progressively increase along a direction away from the incident surface. The size of each V-shaped projection can be defined by the equation:
y=0.0001x²+0.0005x+0.0023

In the above formula, x represents an average distance between the V-shaped projection and the incident surface; and y represents a base breadth of the V-shaped projection. The V-shaped projections are generally parallel triangular prisms. The light guide plate can be one of a parallelepiped-shaped piece and a wedge-shape piece.

In another aspect of the present invention, there is provided a backlight module. The backlight module includes a light source and a light guide plate. The light guide plate is disposed adjacent the light source. The light guide plate includes an incident surface, a reflecting surface, and a plurality of V-shaped projections arrayed on the reflecting surface. The V-shaped projections extend outwardly from the reflecting surface. Each of the V-shaped projection has a triangular cross-section. A vertex angle of the cross-section is in the range from 40° to 95°. A first base angle of the cross-section is in the range from 70° to 90°. A second base angle of the cross-section is in the range from 15° to 50°.

Other advantages and novel features will become more apparent from the following detailed description when taken in conjunction with the accompanying drawings, in which:

### BRIEF DESCRIPTION OF THE DRAWINGS

FIG. 1 is a simplified, isometric view of a light guide plate in accordance with a preferred embodiment of the present invention, together with a light source assembly;

FIG. 2 is an enlarged view of a circled portion II of the light guide plate of FIG. 1;

FIG. 3 is a graph of normalized luminance versus first emergence angle for the light guide plate of FIG. 1, the first emergence angle being defined with respect to an incident direction of light beams from a light source;

FIG. 4 is a graph of normalized luminance versus second emergence angle for the light guide plate of FIG. 1, the second emergence angle being defined with respect to a line normal to an emergence surface of the light guide plate;

FIG. 5 is a graph of normalized luminance versus emergence position along the incident direction of the light beams, corresponding to the first emergence angle of FIG. 3;

FIG. 6 is a graph of normalized luminance versus emergence position along the direction normal to the emergence surface of the light guide plate of FIG. 1, corresponding to the second emergence angle of FIG. 4;

FIG. 7 is a simplified, isometric view of a light guide plate in accordance with an alternative embodiment of the present invention, together with a light source assembly;

FIG. 8 is an enlarged, schematic, exploded view of part of a conventional backlight module, showing an essential optical path thereof; and

FIG. 9 is a schematic, side view of part of a conventional light guide plate, showing essential optical paths thereof

### DETAILED DESCRIPTION OF THE PREFERRED EMBODIMENTS

Reference will now be made to the drawings to describe a preferred embodiment of the present invention in detail.

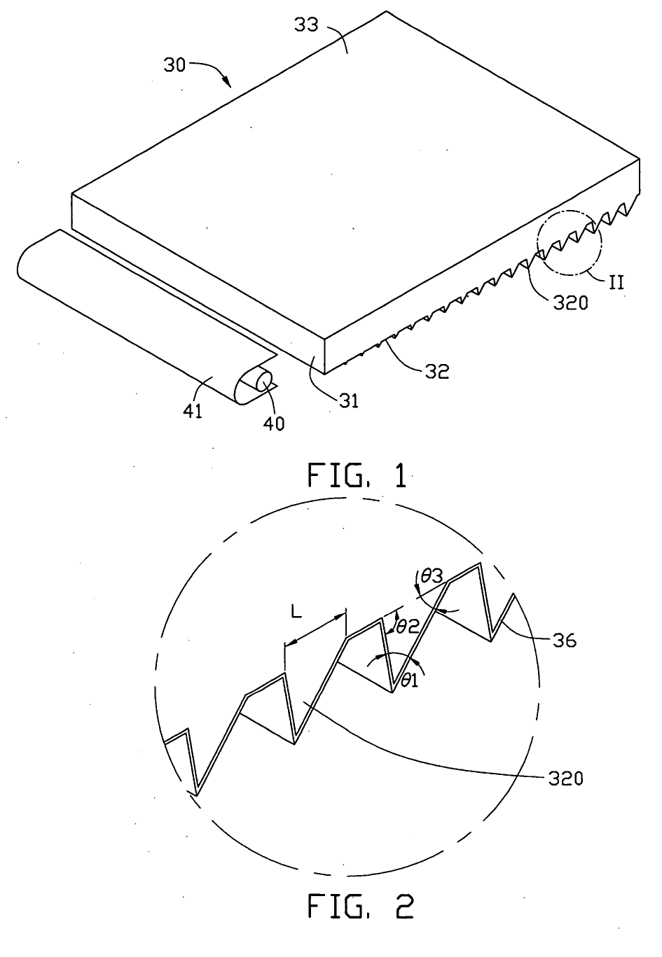

Referring to FIGS. 1 and 2, a backlight module of a display device in accordance with a preferred embodiment of the present invention is depicted. The backlight module comprises a light source assembly, and a plate-like light guide member 30. The light source assembly includes a tubular lamp 40 and a cover 41. A cold cathode tube is generally employed as the tubular lamp 40. Alternatively, the tubular lamp 40 can be substituted with a point light source such as an LED (Light-Emitting Diode). The cover 41 is disposed to surround the lamp 40 in such a way that some light beams emitted by the lamp 40 are reflected toward the light guide plate 30 by the cover 41. The light guide plate 30 comprises an incident surface 31, an emergence surface 33, a reflecting surface 32, and three side surfaces (not labeled) other than the incident surface 31. The light guide plate 30 is disposed adjacent to the light source assembly, with the incident surface 31 facing toward the lamp 40. The light guide plate 30 is generally made of glass or a polymer. In the illustrated embodiment, the light guide plate 30 is made of PMMA (PolyMethyl MethAcrylate). The reflecting surface 32 is opposite to the emergence surface 33. A plurality of V-shaped projections 320 is formed on the reflecting surface 32 in an array. The V-shaped projections 320 extend outwardly from the reflecting surface 32. Preferably, a high-reflecting film 36 is formed on the reflecting surface 32 having the V-shaped projections 320. The high-reflecting film 36 is generally formed of a metallic material such as aluminum. In addition, the remaining three side surfaces of the light guide plate 30 are preferably formed with high-reflecting films (not shown) in order to improve efficiency of light utilization.

In the illustrated exemplary embodiment, a main body of the light guide plate 30 is a sheet having a uniform thickness. The V-shaped projections 320 are triangular prisms 320. In other words, cross-sections of the V-shaped projections are triangular. Each of the prisms 320 extends from one side surface to an opposite side surface, with the prisms 320 being parallel to each other. Each prism 320 has a vertex angle, a first base angle (a projection angle measured from the light guide plate 30), and a second base angle (another projection angle measured from the light guide plate 30). As shown in FIG. 2, the vertex angle and the first and second base angles are denoted with reference characters θ₁, θ₂, and θ₃, respectively The vertex angle θ₁ is preferably in the range from 40° to 95°, the first base angle θ₂ is preferably in the range from 70° to 90°, and the second base angle θ₃ is preferably in the range from 15° to 50°.

In order to improve uniformity of luminance, sizes of the prisms 320 are configured to progressively increase along a direction away from the incident surface 31. That is, the prism 320 nearest the incident surface 31 has a smallest size, and the prism 320 furthest from the incident surface 31 has a largest size. Generally, the sizes of the prisms 320 increase nonlinearly along the direction away from the incident surface 31. The size of each prism 320 can be defined by the equation:
y=0.0001x²+0.0005x+0.0023

Wherein: x represents an average distance between the prism 320 and the incident surface 31; and y represents a base breadth of the prism 320. In FIG. 2, the base breadth is denoted with reference letter “L”. The base breadth L of the prism 320 increases with the average distance between the given prism 320 and the incident surface 31. The base breadth L is preferably configured to be less than 200 μm, so that the prisms 320 are not discernible to the naked eye. In the illustrated embodiment, the base breadth L is in the range from 10 μm to 112 μm.

A distribution density of the prisms 320 can be arranged to progressively increase along the direction away from the incident surface 31. In other words, a distance between adjacent prisms 320 decreases along the direction away from the incident surface 31.

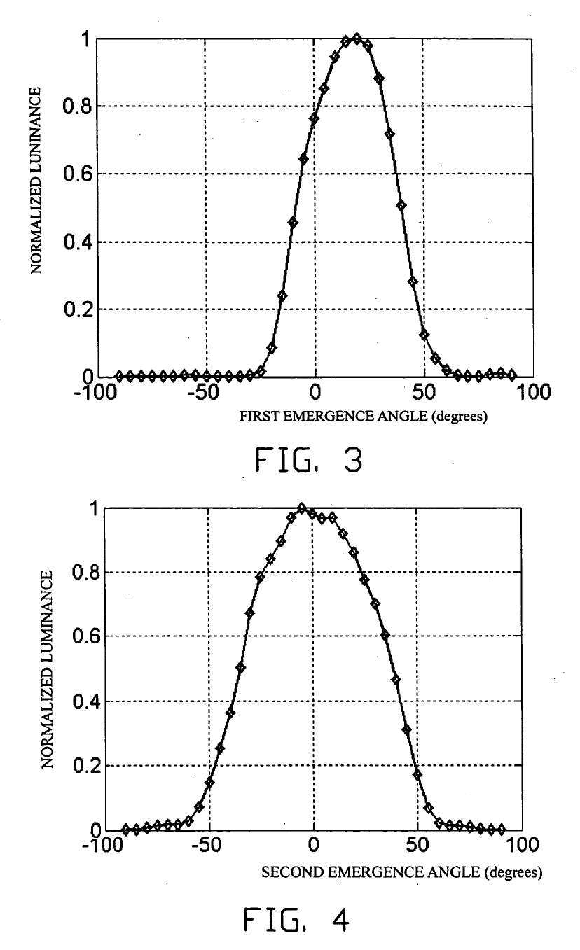

FIGS. 3-6, discussed below, all relate to characteristics of the light guide plate 30.

FIG. 3 is a graph of normalized luminance versus first emergence angle. The first emergence angle is defined with respect to an incident direction of light beams from the light source assembly. FIG. 4 is a graph of normalized luminance versus second emergence angle. The second emergence angle is defined with respect to a line normal to the emergence surface 33 of the light guide plate 30. FIGS. 3 and 4 illustrate an emergence angle distribution of the light beams emitting from the emergence surface 33. As is shown in FIGS. 3 and 4, most of light beams emit perpendicularly from the emergence surface 33.

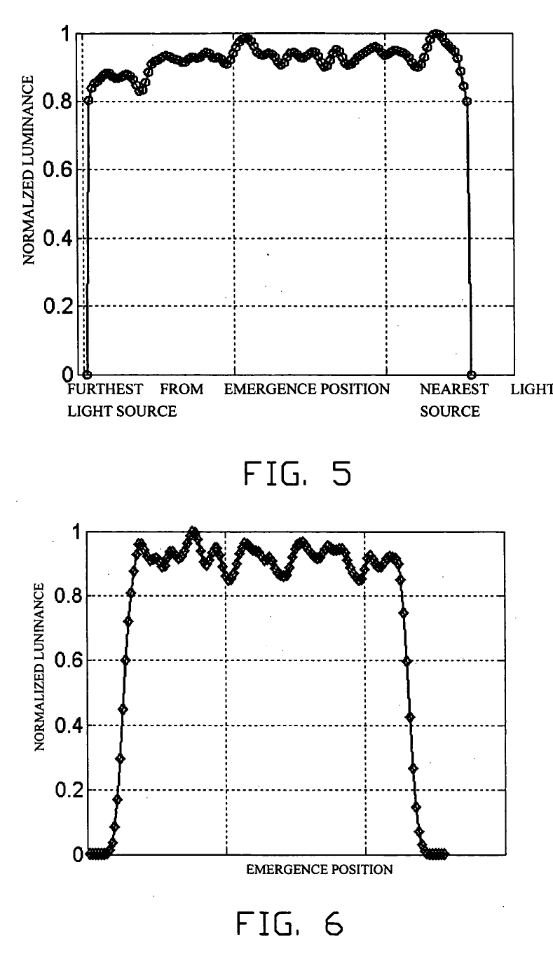

FIG. 5 is a graph of normalized luminance versus emergence position along the incident direction of the light beams, corresponding to the first emergence angle of FIG. 3. FIG. 6 is a graph of normalized luminance versus emergence position along the direction normal to the emergence surface of the light guide plate 30, corresponding to the second emergence angle of FIG. 4. FIGS. 5 and 6 illustrate an interrelationship between luminance and emergence position. As is shown in FIGS. 5 and 6, a satisfactory uniformity of luminance of the light guide plate 30 is achieved along both the incident direction and the normal direction.

The interior angles of the triangular cross-section of each V-shaped projection of the above-described embodiment are respectively configured within the aforementioned corresponding ranges. Thereby, incident light beams from the light source can be directed to exit substantially perpendicularly from the emergence surface of the light guide plate 30. Thus uniformity of luminance can be achieved without the need for employing extra complementary optical elements such as diffusers and prism sheets. In addition, due to absence of the diffusers and prism sheets, the efficiency of light utilization can be improved accordingly. Furthermore, the present backlight module is simpler, easier to assemble and more cost-efficient compared with a conventional backlight module.

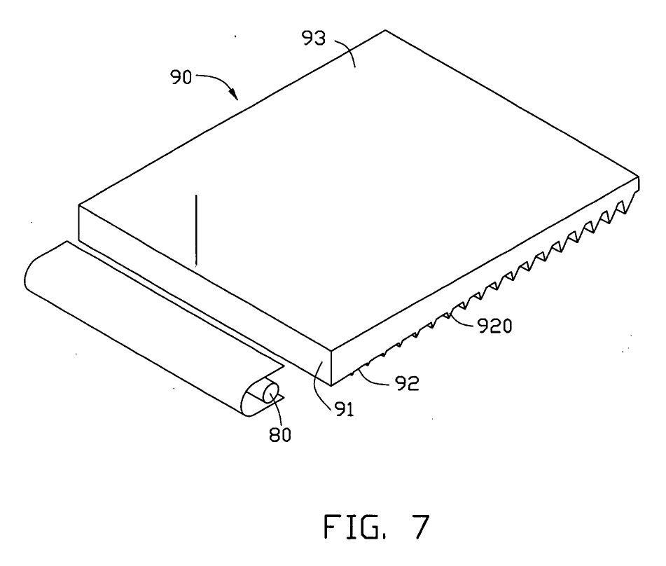

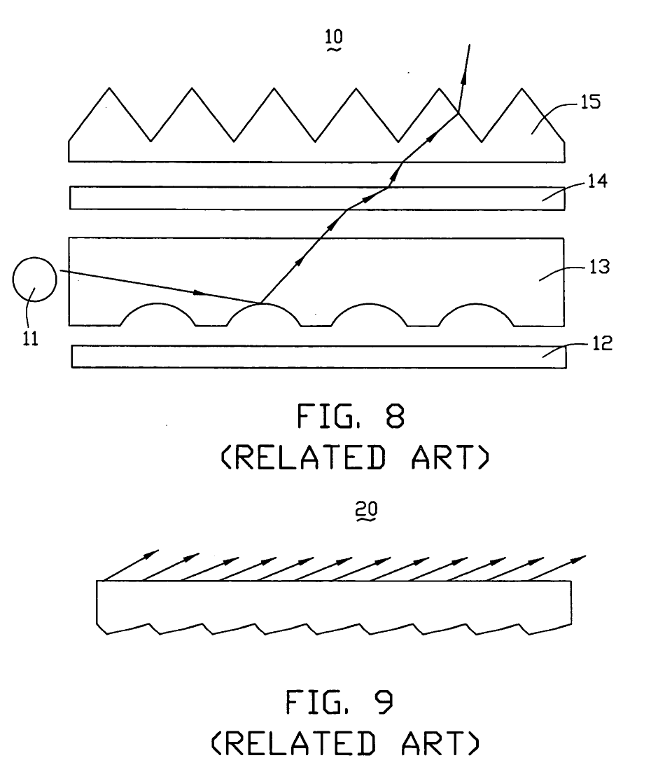

FIG. 7 illustrates a backlight module according to an alternative embodiment of the present invention. The backlight module comprises a light source assembly, and a light guide plate 90. The light source assembly includes a tubular lamp 80 and a cover. The light guide plate 90 comprises an incident surface 91, an emergence surface 93, a reflecting surface 92, and remaining three side surfaces (not labeled). The light guide plate 90 is disposed adjacent the light source assembly, with the incident surface 91 facing toward the lamp 80. The reflecting surface 92 is opposite to the emergence surface 93. A plurality of V-shaped projections 920 is formed on the reflecting surface 92 in an array. The V-shaped projections 920 have triangular cross-sections, and extend outwardly from the reflecting surface 92.

In the illustrated exemplary embodiment, the light guide plate 90 is a wedged-shaped piece. The V-shaped projections 920 are triangular prisms 920. A configuration of each prism 920 is similar to that of each prism 320. For details of such configuration, reference is made to the above description regarding each prism 320.

It is to be further understood that the above-described embodiments illustrate the scope of the invention but do not restrict the scope of the invention. Variations may be made to the embodiments without departing from the spirit or scope of the invention as claimed herein.

What is claimed is:

1. A light guide plate comprising:
an incident surface;
a reflecting surface; and
a plurality of V-shaped projections arrayed on the reflecting surface, the V-shaped projections extending outwardly from the reflecting surface, each of the V-shaped projections having a triangular cross-section, a vertex angle of the cross-section being in the range from 40° to 95°, a first base angle of the cross-section being in the range from 70° to 90°, and a second base angle of the cross-section being in the range from 15° to 50°.

2. The light guide plate as described in claim 1, wherein a distribution density of the V-shaped projections progressively increases along a direction away from the incident surface.

3. The light guide plate as described in claim 1, wherein the cross-sections of the V-shaped projections are similar triangles.

4. The light guide plate as described in claim 1, wherein sizes of the V-shaped projections progressively increase along a direction away from the incident surface.

5. The light guide plate as described in claim 4, wherein the size of each V-shaped projection is defined by the equation: y=0.0001x²+0.0005x+0.0023, wherein: x represents an average distance between the V-shaped projection and the incident surface; and y represents a base breadth of the V-shaped projection.

6. The light guide plate as described in claim 5, wherein the base breadth y is less than 200 μm.

7. The light guide plate as described in claim 6, the base breadth y is in the range from 10 μm to 112 μm.

8. The light guide plate as described in claim 1, wherein the V-shaped projections are prisms that are parallel to each other.

9. The light guide plate as described in claim 1, wherein a high-reflecting film is formed on the reflecting surface of the light guide plate.

10. The light guide plate as described in claim 1, wherein a main body of the light guide plate is one of a sheet having a uniform thickness and a wedge-shaped piece.

11. A backlight module comprising:
a light source;
a light guide plate disposed adjacent the light source, the light guide plate comprising:
an incident surface;
a reflecting surface; and
a plurality of V-shaped projections arrayed on the reflecting surface, the V-shaped projections extending outwardly from the reflecting surface, a size of each V-shaped projection defined by an equation of y=0.0001x2+0.0005x+0.0023, wherein x represents an average distance between the V-shaped projection and the incident surface along the reflecting surface, and y represents a base breadth of the V-shaped projection along the reflecting surface.

12. The backlight module as described in claim 11, wherein a distribution density of the V-shaped projections progressively increases along a direction away from the incident surface.

13. The backlight module as described in claim 11, wherein the cross-sections of the V-shaped projections are similar triangles.

14. The backlight module as described in claim 11, wherein each of the V-shaped projections has a triangular cross-section, a vertex angle of the cross-section is in the range from 40° to 95°, a first base angle of the cross-section is in the range from 70° to 90°, and a second base angle of the cross-section is in the range from 15° to 50°.

15. The backlight module as described in claim 11, wherein the light guide plate is a wedged-shaped piece.

16. The backlight module as described in claim 11, wherein the base breadth y is less than 200 μm.

17. The backlight module as described in claim 16, wherein the base breadth y is in the range from 10 μm to 112 μm.

18. The backlight module as described in claim 11, wherein the V-shaped projections are prisms that are parallel to each other.

19. The backlight module as described in claim 11, wherein a high-reflecting film is formed on the reflecting surface of the light guide plate.

20. A display device comprising:
a light source assembly for providing light of said display device; and
a light guide member disposed next to said light source assembly so as to accept said light from said light source assembly through an incident surface thereof, and to emit said light out of said light guide member through an emergence surface thereof, a plurality of projections interferingly formed in a path of said light in said light guide member to reflect said light from said incident surface toward said emergence surface, a projection angle of each of said plurality of projections from said light guide member and closer to said light source assembly being in a range from 70° to 90°, and another projection angle of said each of said plurality of projections from said light guide member and farther away from said light source assembly being in another range from 15° to 50°.
